(19) United States
(12) Patent Application Publication
(10) Pub. No.: US 2024/0411984 A1
(43) Pub. Date: Dec. 12, 2024

(54) INFORMATION PROCESSING METHOD, INFORMATION PROCESSING SYSTEM, ELECTRONIC DEVICE AND STORAGE MEDIUM

(71) Applicant: BOE Technology Group Co., Ltd., Beijing (CN)

(72) Inventors: Zhexi Li, Beijing (CN); Zongxin Mao, Beijing (CN); Ling Li, Beijing (CN); Chong Guo, Beijing (CN)

(73) Assignee: BOE Technology Group Co., Ltd., Beijing (CN)

(21) Appl. No.: 18/702,526

(22) PCT Filed: Apr. 28, 2023
(86) PCT No.: PCT/CN2023/091593

§ 371 Date: Apr. 18, 2024

(30) Foreign Application Priority Data
Jun. 21, 2022 (CN) 202210708156.X

(51) Int. Cl. G06F 40/186; G06F 40/177

(52) U.S. Cl. CPC G06F 40/186; G06F 40/177

(57) ABSTRACT

Disclosed are an information processing method, an information processing system, an electronic device and a storage medium. The information processing method includes: receiving a plurality of pieces of item information sent by a client, each piece of item information including an occurrence time period of an item and a corresponding timing task, before the current timing task to be triggered is triggered, determining a trigger time point interval between the current timing task to be triggered and the next timing task to be triggered; and based on the trigger time point interval and the sequence of the occurrence time periods, determining a target timing task from the current timing task to be triggered and the next timing task to be triggered, and updating, at a trigger time point of the target timing task, the item list displayed on the terminal.

### CROSS-REFERENCE TO RELATED APPLICATION

The present disclosure claims the priority of the Chinese patent application No. 202210708156.X, filed with the China National Intellectual Property Administration on Jun. 21, 2022 and titled “INFORMATION PROCESSING METHOD, INFORMATION PROCESSING SYSTEM, ELECTRONIC DEVICE AND STORAGE MEDIUM”, which is incorporated herein in its entirety by reference.

### TECHNICAL FIELD

The present disclosure relates to the technical field of displays, in particular to an information processing method, an information processing system, an electronic device and a storage medium.

### BACKGROUND

In the technical field of information display, it is generally necessary to display item information of some items on a terminal in the form of an item list, and during displaying, it is also necessary to continuously update the item list displayed on the terminal according to a sequence of occurrence periods of the items, so that a user knows which items are occurring and which items are about to occur. For example, schedule information of various flights is displayed on a large screen, and a conference reservation list of a physical conference room is displayed on a small flat panel display screen. The conference reservation list may help users know which conferences are reserved in which time periods in the physical conference room.

In the related art, because the item list displayed on the terminal is required to be updated timely, a server is required to update the item list displayed on the terminal based on an occurrence time of each item information. However, when occurrence time of items is very close, the server may frequently update the item list displayed on the terminal. In this case, there will be intensive update events with close time intervals between the server and the terminal. On the one hand, the intensive events may cause thread crash, resulting in update failure, and on the other hand, the intensive update events may cause problems such as network congestion and time delay, resulting in inaccurate update.

### SUMMARY

The present disclosure provides an information processing method, including:
receiving a plurality of item information sent by a client, wherein each item information includes an occurrence period of an item and a corresponding timed task, the timed task is configured to trigger the server at a triggering point in time to update an item list displayed on a terminal, and the item list includes item information of items which are occurring and/or are to occur;
determining a triggering point-in-time interval between a current timed task to be triggered and a next timed task to be triggered before the current timed task to be triggered is triggered; and determining a target timed task from the current timed task to be triggered and the next
timed task to be triggered based on the triggering point-in-time interval and a sequence of the occurrence periods, and updating the item list displayed on the terminal at a triggering point in time of the target timed task.

In an optional embodiment, the determining the target timed task from the current timed task to be triggered and the next timed task to be triggered based on the triggering point-in-time interval and the sequence of the occurrence periods includes:
determining that the current timed task to be triggered and the next timed task to be triggered are target timed tasks when the triggering point-in-time interval is greater than a first preset threshold; and
determining that one with a later occurrence period of the current timed task to be triggered and the next timed task to be triggered is the target timed task when the triggering point-in-time interval is not greater than the first preset threshold.

In an optional embodiment, the method further includes:
determining an interval duration between a first occurrence period and a second occurrence period when the triggering point-in-time interval is greater than or equal to a second preset threshold, wherein the first occurrence period is an occurrence period of an item corresponding to the current timed task to be triggered, and the second occurrence period is an occurrence period of an item corresponding to the next timed task to be triggered;
generating item idle information based on the first occurrence period and the second occurrence period when the interval duration is greater than or equal to a target interval duration, wherein the item idle information is configured to indicate that a period between the first occurrence period and the second occurrence period may be reserved; and
adding the item idle information to the item list displayed on the terminal, so as to display the period which may be reserved in the item list.

In an optional embodiment, the item list is generated by:
receiving an item list template sent by the client; and
generating the item list based on the item list template and the item information of items which are occurring and/or are to occur.

In an optional embodiment, the updating the item list displayed on the terminal at the triggering point in time of the target timed task includes:
acquiring first item information corresponding to the target timed task and second item information at the triggering point in time of the target timed task, wherein an occurrence period of the second item information is after an occurrence period of item information corresponding to the target timed task;
updating a state of the first item information and a state of the second item information which include an occurring state and a non-occurring state;
generating a new item list based on the first item information and the second item information and their updated states; and
sending the new item list to the terminal to update the item list displayed on the terminal.

In an optional embodiment, after the updating the item list displayed on the terminal at the triggering point in time of the target timed task, the method further includes:
when any third item information in the plurality of item information is detected to be updated, generating an updated item list based on the updated third item information and the item list displayed on the terminal; and
sending the updated item list to the terminal, so that the terminal refreshes the displayed item list.

In an optional embodiment, triggering point in time of a timed task corresponding to each item information is determined based on an occurrence period of the item information, and the method further includes:
when an occurrence period of any fourth item information in the plurality of item information is detected to be updated, updating a triggering point in time of a timed task corresponding to the fourth item information based on the updated occurrence period.

In an optional embodiment, after the determining the target timed task, the method further includes:
upon arrival of occurrence period of an item corresponding to the target timed task, sending to the display device item information corresponding to the target timed task, so that the display device refreshes the displayed item information.

In an optional embodiment, a plurality of terminals are included, and the method further includes:
receiving a current performance parameter sent by each of the plurality of terminals, wherein the current performance parameter includes, but is not limited to, at least one of remaining power and signal intensity; and
the updating the item list displayed on the terminal at the triggering point in time of the target timed task includes:
updating the item list displayed on a target terminal at the triggering point in time of the target timed task, wherein the current performance parameter of the target terminal is greater than or equal to a target performance parameter.

The embodiments of the present disclosure provide an information processing method applied to a client, including:
acquiring input item information in response to item input on an item reservation interface, wherein the item information includes an occurrence period of an item and a corresponding timed task, the timed task is configured to trigger a server at a triggering point in time to update an item list displayed on a terminal, and the item list includes item information of items which are occurring and/or are to occur;
sending the item information to the server, so that the server determines a triggering point-in-time interval between a current timed task to be triggered and a next timed task to be triggered before the current timed task to be triggered is triggered, determines a target timed task from the current timed task to be triggered and the next timed task to be triggered based on the triggering point-in-time interval and a sequence of the occurrence periods, and updates the item list displayed on the terminal at a triggering point in time of the target timed task.

In an optional embodiment, before the sending the item information to the server, the method further includes:
acquiring a drawn item list template in response to completion of a drawing operation for an item list template on a template setting interface; and
exporting the item list template as JavaScript Object Notation (JSON) type data, and uploading the item list template to the server, so that the server generates the item list based on the acquired item list template and the item information of items which are occurring and/or are to occur.

In an optional embodiment, the template setting interface includes a table configuration item, and the acquiring the drawn item list template in response to completion of the drawing operation for the item list template on the template setting interface, includes:
generating a table in response to a table attribute parameter input in the table configuration item, wherein the table attribute parameter includes at least one of table size, a number of rows and a number of columns;
receiving text input in the table configuration item for a cell as a table header, and a table header text attribute of the text; and
adding a corresponding text to the cell as the table header based on the table header text attribute to obtain the item list template.

In an optional embodiment, before the adding the corresponding text to the cell as the table header based on the table header text attribute to obtain the item list template, the method further includes:
receiving a table body text attribute input in the table configuration item for a cell that is not a table header; and
the adding the corresponding text to the cell as the table header based on the table header text attribute to obtain the item list template includes:

adding a corresponding text to the cell as the table header based on the table header text attribute and binding the table body text attribute to a corresponding cell to obtain the item list template.

In an optional embodiment, the generating the table in response to the table attribute parameter input in the table configuration item includes:
acquiring a table coordinate system of a display screen to be displayed in response to the table attribute parameter input in the table configuration item;
determining a position coordinate of each cell in the table coordinate system based on the table attribute parameter and the table coordinate system; and
generating the table based on the position coordinate of each cell in the table coordinate system.

In an optional embodiment, uploading the item list template to the server includes:
exporting the item list template as JSON type data and uploading the item list template to the server.

In an optional embodiment, the template setting interface includes a drawing canvas, and before the acquiring the drawn item list template in response to completion of the drawing operation for the item list template on the template setting interface, the method further includes:
recording, for each drawing operation on the template setting interface, a template element generated based on the drawing operation, wherein each template element represents an item list template modified each time, the drawing operation includes, but is not limited to, any of a drawing operation for graphics in the item list template and an editing operation for the table attribute parameter; and
in response to a triggered undo/redo operation, rendering a target template element corresponding to the undo/redo operation in the recorded template elements to the drawing canvas.

In an optional embodiment, the recording, for each drawing operation on the template setting interface, the template element generated based on the drawing operation includes:
exporting, for each drawing operation on the template setting interface; current content on the drawing canvas as data in JSON format; and
taking a snapshot of the exported data in JSON format as a recorded template element.

In an optional embodiment, in response to the triggered undo/redo operation, rendering the target template element corresponding to the undo/redo operation in recorded template elements to the drawing canvas includes:
determining an operation step length of the undo/redo operation; and
searching, based on the operation step length, for a target template element corresponding to the operation step length since a last recorded template element, and rendering the target template element to the drawing canvas, wherein the operation step length includes a length step of an undo type and a step length of a redo type.

In an optional embodiment, the method further includes:
creating a global state object corresponding to the drawing canvas;
recording, at each recording of a template element, the template element and a number of operation steps corresponding to the template element in the global state object, wherein the number of operation steps is configured to indicate a drawing operation corresponding to the template element; and
the searching, based on the operation step length, for the target template element corresponding to the operation step length since the last recorded template element includes:
searching, based on the operation step length, for a template element corresponding to a number of operation steps and the operation step length from the global state object.

In an optional embodiment, template elements in the global state object are arranged in an order of a number of operation steps, and the method further includes:
deleting template elements behind the target template element when the target template
element is not the last recorded template element; and/or deleting template elements arranged at the front when a number of template elements in the global state object exceeds a target number; and
recording, at each recording of a template element, the template element and a number of operation steps corresponding to the template element in the global state object includes:
appending, at each recording of the template element, the template element to a tail of a queue of the template elements, and updating the number of operation steps for the template element.

The present disclosure provides an information processing system, including:
a client, configured to send a plurality of item information to a server, wherein each item information includes an occurrence period of an item and a corresponding timed task, the timed task is configured to trigger the server to update an item list displayed on a terminal, and the item list includes item information of items which are occurring and/or are to occur;
a server, configured to determine a second timed task to be triggered before a current first timed task to be triggered is triggered, determine a target timed task based on a sequence of the occurrence periods and an interval between triggering points in time of the first timed task and the second timed task, and update the item list displayed on the terminal at a triggering point in time of the target timed task; and
a terminal, configured to refresh the displayed item list based on the item list sent by the server.

The present disclosure provides an electronic device, including a memory, a processor and a computer program stored in the memory and run on the processor, wherein the processor, when executing, performs the information processing method.

The present disclosure further provides a non-transitory computer-readable storage medium, and a computer program stored thereon causes the processor to implement the information processing method.

The above description is only an overview of the technical solution of the present application. In order to have a clearer understanding of the technical means of the present application, it can be implemented according to the content of the specification. In order to make the above and other purposes, features, and advantages of the present application more obvious and easier to understand, the specific implementations of the present application are listed below.

### BRIEF DESCRIPTION OF THE DRAWINGS

To describe the technical solutions in the embodiments or the related art of the present disclosure more clearly, the following briefly introduces the accompanying drawings required for describing the embodiments or the related art. Apparently, the accompanying drawings in the following description show merely some embodiments of the present disclosure, and a person of ordinary skill in the art may still derive other drawings from these accompanying drawings without creative efforts. It should be noted that the scales in the drawings are for illustration only and do not represent actual scales.

FIG. 1 schematically shows an implementation environment diagram of an information processing method provided in the present disclosure;

FIG. 2 schematically shows a flowchart of steps of an information processing method provided in an embodiment of the present disclosure;

FIG. 3 schematically shows a flowchart of steps of an information processing method provided in the present disclosure;

FIG. 4 schematically shows a schematic diagram of an item list template in a conference reservation scenario provided in the present disclosure;

FIG. 5 schematically shows a flowchart of steps of acquiring a drawn item list template provided in the present disclosure;

FIG. 6 schematically shows a schematic diagram of calculating position coordinates of each cell based on a table coordinate system provided in the present disclosure;

FIG. 7 schematically shows an overall schematic flowchart of how to obtain a conference list template in a conference reservation scenario provided in the present disclosure;

and

FIG. 8 schematically shows a schematic framework diagram of an information processing system provided in the present disclosure.

### DETAILED DESCRIPTION OF THE EMBODIMENTS

In order to make the objectives, technical solutions and advantages of the embodiments of the present disclosure more clearly, the technical solutions in the embodiments of the present disclosure will be described clearly and completely in conjunction with the accompanying drawings in the embodiments of the present disclosure. Apparently, the described embodiments are merely some embodiments, rather than all embodiments, of the present disclosure. Based on the embodiments of the present disclosure, all other embodiments derived by a person of ordinary skill in the art without creative efforts shall fall within the protection scope of the present disclosure.

With a conference reservation list of a physical conference room (hereinafter referred to as a conference reservation scenario) displayed on a small-sized flat panel display screen as an example, the problems existing in the related art are explained as follows.

Generally, in an enterprise, a plurality of physical conference rooms may be provided for offline conferences. In general, various business departments in the enterprise may share the physical conference rooms. When there are more business departments, there may be more conferences, so it is necessary to make a reservation for the physical conference room in advance. Therefore, a conference system will be provided to meet the reservation service for physical conference rooms in the enterprise. The reservation information for the physical conference room may include a holding time period, a host, participating departments, participants and other information of a conference. One physical conference room may correspond to a plurality of reservation information. Of course, in order avoid conflicts between conference reservation time periods of the same physical conference room, the time periods in the reservation information do not coincide with each other.

In an actual scenario, conference reservation information of a physical conference room may be displayed on an electronic doorplate of the physical conference room. The electronic doorplate is a small display screen that displays a conference list in which the conference reservation information of the physical conference room is listed. Generally, it is necessary for enterprise employees to determine when there is a conference, an conference which is not held and an ongoing conference in the physical conference room through the electronic doorplate.

Therefore, the conference list on the electronic doorplate is required to be updated in real time based on a reservation time period corresponding to the conference reservation information. In the related art, there are two timed tasks bound to each conference reservation information, one is a timed task before the conference, which is configured to trigger the update of a conference list before the conference; and the other is a timed task near the end of the conference, which is configured to trigger the update of the conference list when the conference is about to end. In this way, when reservation time periods of two pieces of conference reservation information are very close, a plurality of update events for the conference list may be generated within a short time interval. On the one hand, such intensive update events may cause the thread crash, resulting in update failure; and on the other hand, the intensive update events may cause network congestion and update delay, resulting in inaccurate update.

Of course, the above is only an exemplary illustration of the technical problems arising from the related art. In practice, similar technical problems exist in other application scenarios. For example, the same problems may also be caused in the display of flight or train schedule information.

In view of this, the present disclosure proposes a technical concept to solve the above problems. Specifically, before each timed task is triggered, a next timed task to be triggered is determined, and a target timed task to be triggered is selected based on a sequence of occurrence periods of two timed tasks and a time interval between triggering points in time (hereinafter referred to as a triggering point-in-time interval), so as to update an item list on a terminal at a triggering point in time of the target timed task. If a time interval between the triggering points in time of two adjacent triggered timed tasks is short, one of two adjacent timed tasks may be selected to be triggered based on the sequence of the occurrence periods, and the other timed task may not be triggered. Therefore, a large number of frequent update events in a network caused by the triggering of timed tasks that are very close to each other may be avoided, so as to reduce the update events, avoid thread crash, and improve a success rate of the update of the item list. In addition, the reduction of update events may avoid the congestion of network bandwidth congestion, reduce update delay, and thus improve the success rate and accuracy of the update of the item list.

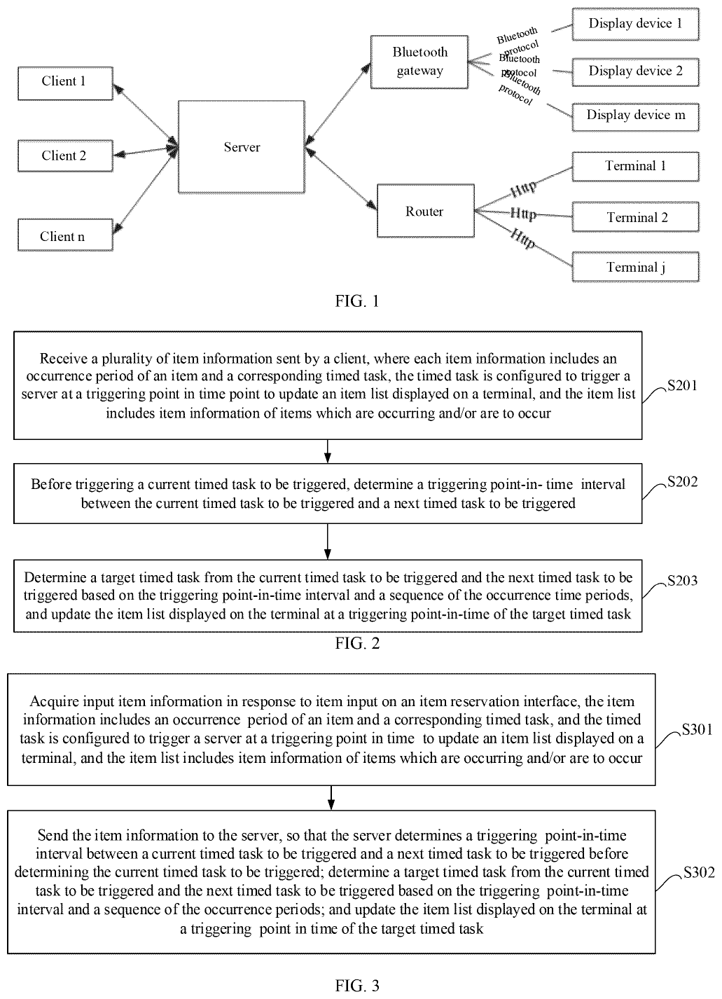

Referring to FIG. 1, an implementation environment diagram of an information processing method of the present disclosure is shown. As shown in FIG. 1, a server, a client, a plurality of terminals and a plurality of display devices are included. The client is communicatively linked to the server, and the server is communicatively linked to the plurality of terminals and the plurality of display devices. Specifically, the plurality of terminals are connected to the server through an HTTP protocol, and the plurality of display devices communicate with the server through a near-network protocol such as Bluetooth. The display devices may communicate with the server through a Bluetooth gateway, and the terminal may communicate with the server through a router. After the terminal is scanned by the router, the router reports basic information of the terminal to the server; and after the display device is scanned by the Bluetooth gateway, the Bluetooth gateway reports basic information of the display device to the server. The basic information may include remaining power, an identification, signal intensity, etc. In a conference reservation scenario, the client is configured to make a reservation for a conference and upload reservation information obtained from the reservation to the server. The server is configured to generate a conference list based on the reservation information, and send the conference list generated based on the corresponding reservation information to the terminal at a triggering point in time of a timed task bound to the reservation information. The terminal may be the above electronic doorplate, and is configured to display the conference list sent by the server.

It can be seen from FIG. 1 that the server may be required to initiate an update event of the conference list to a plurality of terminals within a short time, so a large number of frequent update events in the network may cause network congestion, greatly increase the probability of errors in updating the conference list. Moreover, a large number of update events may easily cause the thread crash, resulting in failure of list updating.

Combined with the implementation environment shown in FIG. 1, the information processing method of the present disclosure is introduced with an application scenario of conference reservation as an example. As shown in FIG. 2, a flowchart of steps of an information processing method in an embodiment is shown. In this embodiment, how to execute the information processing method is described from the server side. Of course, this embodiment is only illustrated with the application scenario of conference reservation as an example, and may still be applied to other similar scenarios, such as a shift information display scenario. As shown in FIG. 2, the method may include the following specific steps.

In step S201, a plurality of item information sent by a client is received. Each item information includes an occurrence period of an item and a corresponding timed task.

The timed task is configured to trigger the server at a triggering point in time to update an item list displayed on a terminal. The item list showing item information of items which are occurring and are to occur.

In this embodiment, the client may be a Web client. A user may log in to the client in a browser, in order to input item information of an item to be reserved in an item reservation interface provided by the client, and upload the item information to the server. Each item information includes an occurrence period of an item. The occurrence period refers to a time period in which the item is carried out. A timed task may be carried in the item information, or a timed task may be bound to the item information and then sent separately from the item information. The binding may refer to an association between an identification of the timed task and an identification of the item information, as long as an association relationship between the item information and the timed task is determined.

The terminal is configured to display an item list. The item list includes item information of items that are occurring and/or are to occur. Specifically, in some scenarios, the item list may include items that are occurring, and the items that are occurring refer to items that occur at the current time. In further scenarios, the item list may include items that are to occur, and the items that are to occur refer to items that have not yet occurred at the current time. In other scenarios, the item list may include items that are to occur and items that are occurring.

In this embodiment, the timed task corresponding to each item information may have its own triggering point in time, which may be set based on the occurrence period. Generally speaking, the triggering point in time may be set before the occurrence period, or at an end of the occurrence period, or during the occurrence period, or all of the above, to be specific, according to user requirement. Different item information may be allowed to personalize different triggering points in time of timed tasks. For example, triggering points in time of timed tasks of some item information are set at the end of the occurrence period, while triggering points in time of timed tasks of other item information may be set before the occurrence period. One item information may also be allowed to correspond to one timed task or a plurality of timed tasks.

During specific implementation, the timed task may be triggered at its own triggering point in time. When the timed task is triggered at the triggering point in time, the item information corresponding to the timed task is required to be displayed on the terminal or cleared from the item list displayed on the terminal. Therefore, in response to the triggering, the server may determine item information to be displayed on the terminal, and then update the item list displayed on the terminal according to the item information to be currently displayed on the terminal, so that the item list displayed on the terminal includes only items that are occurring, or only items that are to occur, or both items that are to occur and items that are occurring.

In an optional example, the item information may be conference reservation information when applied to an application scenario of conference reservation. The conference reservation information includes a reservation period. The reservation period is an occurrence period which may be understood as a holding period of a conference. In this case, the timed task may be configured to trigger the server to update the conference list on the terminal, in order to display reservation information of conferences that are being held and are to be held subsequently. The item information may be schedule information when applied to an application scenario of schedule information display. The schedule information includes a departure time and an arrival time, and a time period between the departure time and the arrival time is called an occurrence period. The timed task may be configured to trigger the server to update a schedule information list (i.e., the item list) displayed on a large screen in order to display schedule information about departure time.

In step S202, before a current timed task to be triggered is triggered, a triggering point-in-time interval between the current timed task to be triggered and a next timed task to be triggered is determined.

In this embodiment, since each timed task has its own triggering point in time, before each timed task is triggered at its corresponding triggering point in time, a triggering point-in-time interval between the current timed task to be triggered and the next timed task to be triggered may be determined.

In an example #, item information 1 corresponds to a timed task 1, item information 2 corresponds to a timed task 2, and item information 3 corresponds to a timed task 3. The triggering point in time of the timed task 1 is 12:55, the triggering point in time of the timed task 2 is 12:50, the triggering point in time of the timed task 3 is 13:01, and the timed task 2 is triggered at 12:50. Before the triggering point in time of the timed task 2, i.e., before 12:50, the next timed task to be triggered, that is, the timed task 1, may be determined at 12:49, for example. A triggering point-in-time interval between two adjacent triggered timed tasks may be determined.

If the triggering point-in-time interval is short (e.g., an interval of one minute), a plurality of intensive update events will be generated when there is a large amount of item information in the server. If the triggering point-in-time interval is long (e.g., an interval of ten minutes), a plurality of intensive update events are generally not generated.

Of course, in some scenarios, the item information corresponding to the current timed task to be triggered and the item information corresponding to the next timed task to be triggered are required to belong to the same project. For example, in a conference reservation scenario, the current timed task to be triggered and the next timed task to be triggered are required to correspond to one physical conference room. For example, in a schedule information display scenario, the current timed task to be triggered and the next timed task to be triggered are required to correspond to the same line, the same airline, or the same waiting room.

In step S203, a target timed task is determined from the current timed task to be triggered and the next timed task to be triggered based on the triggering point-in-time interval and a sequence of occurrence periods, and the item list displayed on the terminal is updated at a triggering point in time of the target timed task.

In this embodiment, one of the current timed task to be triggered and the next timed task to be triggered is determined to be retained in combination with the triggering point-in-time interval and the sequence of occurrence periods, and the retained timed task is called the target timed task.

Specifically, in the case of a short triggering point-in-time interval, the current timed task to be triggered or the next timed task to be triggered may be selected to retain. It should be noted that because different item information may be allowed to personalize different triggering points in time of the timed tasks, an occurrence period of an item corresponding to a timed task with an earlier triggering point in time is not necessarily earlier than an occurrence period of an item corresponding to a timed task with a later triggering point in time. Therefore, in the case of a short triggering point-in-time interval, which timed task to be retained may be determined according to the sequence of the occurrence periods. For example, in some scenarios, a timed task with a later occurrence period is retained, while in other scenarios, a timed task with an earlier occurrence period is retained.

In the case of a long triggering point-in-time interval, a plurality of intensive update events are generally not generated. Therefore, the current timed task to be triggered and the next timed task to be triggered may be retained. Of course, in some other scenarios with requirements, one of the timed tasks may also be retained based on the sequence of occurrence periods.

With the above example # as an example, before the timed task 2 is triggered at 12:50, the timed task 1 is determined as the next task to be triggered, and a triggering point-in-time interval between two tasks is 5 minutes, and the triggering point-in-time interval is short. Therefore, the timed task with a later occurrence period may be retained. The occurrence period corresponding to the timed task 1 is 12:00-13:00, and the occurrence period corresponding to the timed task 2 is 13:00-14:00. It may be seen that the occurrence period of the timed task 1 is earlier. Therefore, the timed task 1 is canceled, and the timed task 2 is retained as the target timed task. When the timed task 2 is triggered at 12:50, the server may update the item list displayed on the terminal. Therefore, no timed task is triggered at 12:55, which does not result in a burst of intensive update events.

In the technical solutions of the embodiments of the present disclosure, for the triggering of the timed tasks, one of two adjacent triggered timed tasks may be retained as the target timed task based on the triggering point-in-time interval between two adjacent triggered timed tasks and the sequence of corresponding occurrence periods, and then the item list displayed on the terminal is updated at the triggering point in time of the target timed task. Therefore, a large number of frequent update events caused by the triggering of timed tasks at a very close interval may be avoided. For the server, reducing the update events may avoid thread crash and improve a success rate of item list update. For the network environment where the server and the terminal are located, reducing update events within a short time may avoid network congestion, reduce update delay, and ensure the accuracy of the update.

In an optional embodiment, a process of determining the target timed task is shown.

When the target timed task is determined, a timed task with a later occurrence period may be selected as the target timed task in the case of a short triggering point-in-time interval, while the current timed task to be triggered and the next timed task to be triggered may both be retained as the target timed tasks in the case of a long triggering point-in-time interval.

Specifically, when the triggering point-in-time interval is greater than a first preset threshold, the current timed task to be triggered and the next timed task to be triggered are both determined as the target timed tasks; and when the time interval is not greater than the first preset threshold, one with a later occurrence period of the current timed task to be triggered and the next timed task to be triggered is determined as the target timed task.

In this embodiment, the first preset threshold may be determined based on performance of the server and the network environment, for example, it may be determined as 10 minutes, or as short as 5 minutes. The triggering point-in-time interval is greater than the first preset threshold, the interval duration between update events sent by the server is long and may not lead to the occurrence of intensive update events. Therefore, two timed tasks may both be retained as the target timed tasks.

When the triggering point-in-time interval is not greater than the first preset threshold, the interval duration between the update events sent by the server is short and may lead to the occurrence of intensive update events. Therefore, one with a later occurrence period of two timed tasks may be determined as the target timed task. Determining the timed task with a later occurrence period as the target timed task may facilitate the server to update item information of items that are to occur to a terminal list, in order to meet the user requirements in the conference reservation scenario. In an optional example, when the triggering point-in-time interval is not greater than the first preset threshold, two timed tasks are triggered at different points in time or two timed tasks are triggered at the same point in time. When the triggering points in time are the same, in two timed tasks with the same triggering points in time, the timed task corresponding to the item information with the later occurrence period may be canceled.

In the following, combined with three specific examples of the conference reservation scenario, the process of determining the target timed task in the present disclosure is exemplary illustrated.

Specific example 1: four conferences are reserved in a physical conference room 1 in the afternoon of a certain day in a certain month of a certain year. As shown in Table 1 below, Table 1 shows a conference list corresponding to the physical conference room 1.

TABLE 1
Conference list corresponding to physical conference room 1

| Conference | Conference | | Triggering point in |
|---|---|---|---|
| room name | name | Conference time | time of timed task |
| Conference | Conference | 13:00-14:00 | 5 minutes before |
| room 1 | 1 | | conference + 5 minutes |
| | | | before the end of |
| | | | conference |
| Conference | Conference | 14:00-15:00 | 10 minutes before |
| room 1 | 2 | | conference + 10 minutes |
| | | | before the end of |
| | | | conference |
| Conference | Conference | 16:00-17:00 | 10 minutes before |
| room 1 | 3 | | conference + 10 minutes |
| | | | before the end of |
| | | | conference |
| Conference | Conference | 17:00-17:30 | 10 minutes before |
| room 1 | 4 | | conference + 10 minutes |
| | | | before the end of |
| | | | conference |

As shown in Table 1, there are four conferences in the afternoon, and there are two timed tasks for Conference 1, which are triggered at 12:55 and 13:55, respectively. There are two timed tasks for Conference 2, which are triggered at 13:50 and 14:50, respectively. The timed task at 13:50 for Conference 2 is triggered first, and the timed task at 13:55 for Conference 1 is triggered next, so a triggering point-in-time interval is short. In addition, a conference time (Conference 2) corresponding to the timed task at 13:50 is after a conference time (Conference 1) corresponding to the timed task at 13:55. In this case, the timed task at 13:55 may be automatically canceled, and the server may update the conference list at 13:50. During the update, conference reservation information of the conference room 1 will no longer be sent directly to the terminal. The updated conference list displayed on the terminal includes conference reservation information of Conference 2 to Conference 4.

Specific example 2: four conferences are reserved in a physical conference room 2 in the afternoon of a certain day in a certain month of a certain year. As shown in Table 2 below, Table 2 shows a conference list corresponding to the physical conference room 2.

As shown in Table 2, there are four conferences in the conference room 2 in that afternoon, and there are two timed tasks for Conference 1, which are triggered at 12:50 and 13:50, respectively.

TABLE 2
Conference list corresponding to physical conference room 2

| Conference | Conference | | Triggering point in |
|---|---|---|---|
| room name | name | Conference time | time of timed task |
| Conference | Conference | 13:00-14:00 | 10 minutes before |
| room 2 | 1 | | conference + 10 minutes |
| | | | before the end of |
| | | | conference |
| Conference | Conference | 14:00-15:00 | 5 minutes before |
| room 2 | 2 | | conference + 5 minutes |
| | | | before the end of |
| | | | conference |
| Conference | Conference | 16:00-17:00 | 10 minutes before |
| room 2 | 3 | | conference + 10 minutes |
| | | | before the end of |
| | | | conference |
| Conference | Conference | 17:00-17:30 | 10 minutes before |
| room 2 | 4 | | conference + 10 minutes |
| | | | before the end of |
| | | | conference |

There are two timed tasks for Conference 2 has, which are triggered at 13:55 and 14:55, respectively. When the timed task at 13:50 is to be triggered, the timed task at 13:55 may be determined to be triggered next, so a triggering point-in-time interval is short. In addition, a conference time (Conference 2) corresponding to the timed task at 13:55 is after a conference time (Conference 1) corresponding to the timed task at 13:50. In this case, the timed task at 13:50 will not be triggered and will be automatically canceled. Wait for the timed task at 13:55 to be triggered. The server may update the conference list at 13:55. The updated conference list displayed on the terminal includes conference reservation information of Conference 2 to Conference 4.

Specific example 3: four conferences are reserved in a physical conference room 3 in the afternoon of a certain day in a certain month of a certain year. As shown in Table 3 below, Table 3 shows a conference list corresponding to the physical conference room 3.

TABLE 3
Conference list corresponding to physical conference room 3

| Conference | Conference | | Triggering point in |
|---|---|---|---|
| room name | name | Conference time | time of timed task |
| Conference | Conference | 13:00-14:00 | 5 minutes before |
| room 3 | 1 | | conference + 5 minutes |
| | | | before the end of |
| | | | conference |
| Conference | Conference | 14:00-15:00 | 5 minutes before |
| room 3 | 2 | | conference + 5 minutes |
| | | | before the end of |
| | | | conference |
| Conference | Conference | 16:00-17:00 | 10 minutes before |
| room 3 | 3 | | conference + 10 minutes |
| | | | before the end of |
| | | | conference |
| Conference | Conference | 17:00-17:30 | 10 minutes before |
| room 3 | 4 | | conference + 10 minutes |
| | | | before the end of |
| | | | conference |

As shown in Table 3, there are four conferences in the conference room 3 in the afternoon of that day. There are two timed tasks for Conference 1, which are triggered at 12:55 and 13:55, respectively. There are two timed tasks for Conference 2, which are triggered at 13:55 and 14:55, respectively. When the timed task at 13:55 is to be triggered, another timed task at 13:55 may be determined at the same time, with the same triggering point in time. In this case, Conference 1 occurs earlier, and the timed task corresponding to Conference 1 is canceled. The conference list is updated based on the triggering of the timed task of Conference 2. The updated conference list displayed on the terminal includes conference reservation information of Conference 2 to Conference 4.

In an optional embodiment, when the target timed task is determined, whether the triggering point-in-time interval is sufficient to meet the occurrence of an item may be determined in the case of a long triggering point-in-time interval. If so, the terminal may be instructed to display information of idle time in this interval duration to inform a user of items that may be reserved within the period.

In specific implementation, when the triggering point-in-time interval is greater than or equal to a second preset threshold, an interval duration between a first occurrence period and a second occurrence period is determined. The first occurrence period is an occurrence period of an item corresponding to the current timed task to be triggered, and the second occurrence period is an occurrence period of an item corresponding to the next timed task to be triggered.

When the interval duration is greater than or equal to a target interval duration, item idle information is sent to be terminal and/or the client based on the first occurrence period and the second occurrence period. The item idle information is configured to indicate that a period between the first occurrence period and the second occurrence period is available for reservation.

Of course, in specific implementation, the item idle information may be added to the item list displayed on the terminal, so as to display the period available for reservation in the item list. In this case, the item idle information may be added to an implementation list and located in a position between the item information corresponding to the current timed task to be triggered and the item information corresponding to the next timed task to be triggered.

In this embodiment, if the triggering point-in-time interval is long and is greater than the second preset threshold, it indicates that there is a long interval duration between occurrence periods of items corresponding to two timed tasks. In this case, an interval duration between the first occurrence period of the item corresponding to the current timed task to be triggered and the second occurrence period of the item corresponding to the next timed task to be triggered may be determined. The second preset threshold is greater than the first preset threshold.

When the first occurrence period occurs earlier, the interval duration may refer to an interval time between an end time of the first occurrence period and a start time of the second occurrence period. When the first occurrence period occurs later, the interval duration may refer to an interval time between an end time of the second occurrence period and a start time of the first occurrence period.

When the interval duration is greater than or equal to a target interval duration, item idle information may be sent to be terminal and/or the client. The item idle information may be generated based on the period between the first occurrence period and the second occurrence period. The period between the first occurrence period and the second occurrence period may be referred to as an idle period. The item idle information is mainly configured to indicate that the idle period may be reserved.

In the conference reservation scenario, the item idle information may also include a conference room identification to identify which period in a physical conference room may also be reserved for the conference. The target interval duration may be set based on actual requirements, for example, it may be set to be greater than 30 minutes.

Specific example 4: four conferences are reserved in a physical conference room 4 in the afternoon of a certain day in a certain month of a certain year. As shown in Table 4 below, Table 4 shows a conference list corresponding to the physical conference room 4.

TABLE 4
Conference list corresponding to physical conference room 4

| Conference | Conference | | Triggering point in |
|---|---|---|---|
| room name | name | Conference time | time of timed task |
| Conference | Conference | 13:00-14:00 | 5 minutes before |
| room 4 | 1 | | conference + 5 minutes |
| | | | before the end of |
| | | | conference |
| Conference | Conference | 14:00-15:00 | 5 minutes before |
| room 4 | 2 | | conference + 5 minutes |
| | | | before the end of |
| | | | conference |
| Conference | Conference | 17:00-17:30 | 10 minutes before |
| room 4 | 3 | | conference + 10 minutes |
| | | | before the end of |
| | | | conference |
| Conference | Conference | 17:30-18:00 | 10 minutes before |
| room 4 | 4 | | conference + 10 minutes |
| | | | before the end of |
| | | | conference |

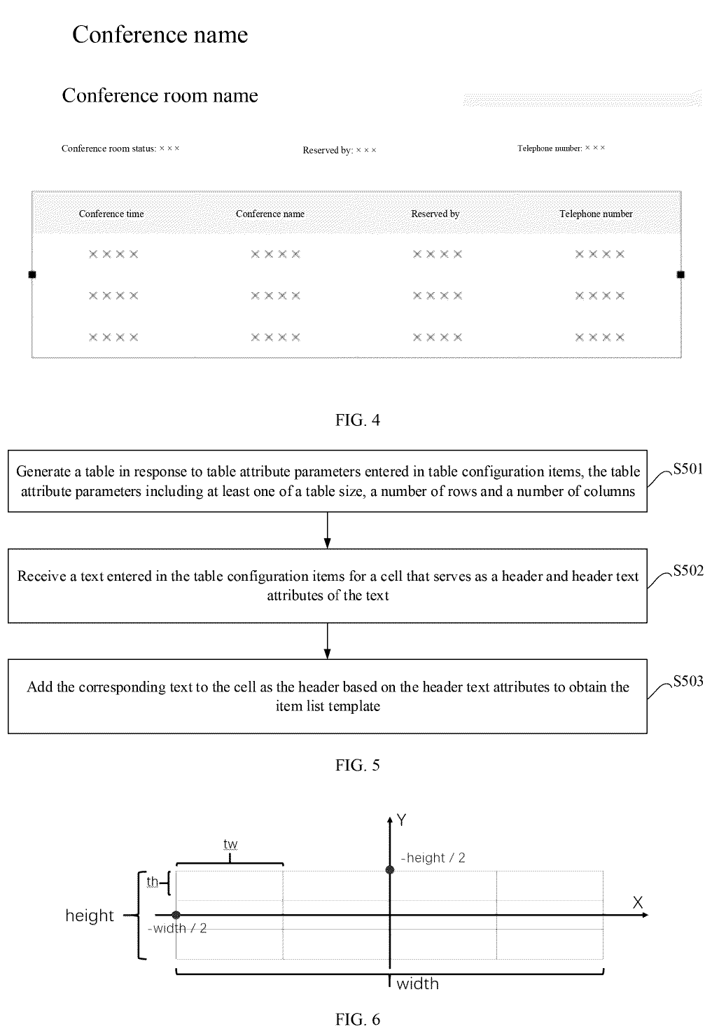

As shown in FIG. 4, with Conference 2 and Conference 3 as examples, when a timed task at 14:55 at the end of Conference 2 is triggered, and a next timed task is a timed task at 16:50 in Conference 3. A triggering point-in-time interval between two timed tasks is 1 hour and 50 minutes, which is large enough. Therefore, an interval duration between Conference 2 and Conference 3 may be further determined. It may be seen that the interval duration is 2 hours, which may be reserved for one or more conferences. Therefore, the item idle information for the item between 15:00 and 17:00 may be generated to indicate that the period may be reserved. Specifically, the item idle information may be inserted between Conference 2 and Conference 3 in Table 4, and may be marked as “Idle” in the column of conference name, so that “Idle” is displayed before Conference 3 in the conference list on the terminal.

In an optional embodiment, a process of updating the item list is shown.

The updating the item list includes: updating the item list based on the timed tasks, and updating the item list based on modified or newly added item information. The process of updating the item list based on the timed tasks is follows.

The item list may be generated by the server based on item information of the current item that is to occur, and the item information of the current item that is to occur may be determined based on the triggering of the corresponding timed task, that is, it may include item information corresponding to the triggered timed task and item information corresponding to the timed task to be triggered.

In a specific example, an item list template sent by the client may be received. An item list is generated based on the item list template and item information of items that are occurring and/or are to occur.

In specific implementation, the item list template may be produced by the client and uploaded to the server. The production of the item list template may be described in details in the embodiments of the client side later, and will not be repeated here. The item list template may stipulate that the item information of items that are occurring and/or items that are to occur is displayed in the form of a list. In an optional example, the item list template may be understood as a table type template, including rows and columns. A name of the table as a header of the table, such as the first row of the table, may be preset, and each item information may be used as the content of the table body in the table. As shown in Tables 1 to 4, the item list template may be understood as a table that does not include conference reservation information in the table body.

As described above, the item information of items that are occurring and/or are to occur may be displayed in the item list according to requirements. Therefore, when the item list displayed on the terminal is updated, the item information corresponding to the currently triggered timed task may be added to the item list template. With the specific example 1 as an example, the item information of Conference 2 may be added to the item list template at 13:50.

Alternatively, the item information whose occurrence period is after the item corresponding to the currently triggered timed task is added to the item list template. With the specific example 1 as an example, the item information of Conference 3 and Conference 4 may be added to the item list template at 13:50.

Alternatively, the item information corresponding to the currently triggered timed task and the item information whose occurrence period is after the item corresponding to the currently triggered timed task are added to the item list template. With the specific example 1 as an example, the item information of Conference 2, Conference 3 and Conference 4 may be added to the item list template at 13:50.

In specific implementation, in an optional example, a process of updating the list displayed on the terminal is shown. Specifically, first item information corresponding to the target timed task and second item information may be acquired at the triggering point in time of the target timed task. A new item list is generated based on the first item information and the second item information. The new item list is sent to the terminal to update the item list displayed on the terminal.

The occurrence period of the second item information is after the occurrence period of an item corresponding to the target timed task.

In an optional example, the first item information may be understood as information of an item that is occurring, and the second item information may be understood as information of an item that is to occur. The first item information and the second item information may be added to the item list template row by row. During row-by-row addition, the first item information and the second item information may be added to the item list based on the sequence of occurrence periods of the first item information and the second item information, so that a new item list is obtained. The new item list is sent to the terminal, and the terminal may refresh the displayed item list after receiving the new item list, so that the display list on the terminal is updated.

Of course, in a further embodiment, the item list may include a current state of each item information. When the item list is updated, the state of each item information in the item list to be displayed may be updated together.

In specific implementation, when the new item list is generated, a state of the first item information and a state of the second item information may be updated. The new item list may be generated based on the first item information and the second item information, as well as their updated states. The states include an occurring state and a non-occurring state.

The state of the first item information may be determined based on an occurrence period of an item corresponding to the target timed task. If the occurrence period is after the current time and is very close to the current time, it indicates that this item is about to occur, so its state may be changed from the non-occurring state to the occurring state, and the state of the second item information may be maintained as the non-occurring state. Correspondingly, the state of each item information may be identified in the list when the new item list is generated.

With the above tables 1 to 4 as examples, a new column may be added to identify the state of each conference. Of course, in the conference reservation scenario, the state of the conference may include a starting state and a to-be-held state.

In this implementation, the state of each item information in the item list may be updated and identified to help a user acquire which items are occurring and which items are to occur, thereby optimizing the user experience.

The process of updating the item list based on the modified or newly added item information is as follows.

When any third item information in the plurality of item information is detected to be updated, a corresponding updated item list is generated based on the updated first item information and the item list currently displayed on the terminal; and the updated item list is sent to the terminal, so that the terminal refreshes the displayed item list.

In this embodiment, if the client updates one third item information, the item list displayed on the terminal may be updated in real time based on the updated third item information. Specifically, the updated item list may be generated based on the updated third item information and various item information in the item list currently displayed on the terminal, and the updated item list is sent to the terminal; and the terminal may refresh the displayed item list after receiving the new item list, thereby updating the list displayed on the terminal in real time.

The update of the item information may include an update of the occurrence period and an update of other attributes, e.g., in the conference reservation scenario, it further includes an update of the reserved conference room.

In the case that the triggering point in time is generated based on the occurrence period of the item information, the triggering point in time of the corresponding timed task may also be updated when the occurrence period of the item information is detected.

In specific implementation, when an occurrence period of any fourth item information in the plurality of item information is detected to be updated, a triggering point in time of a timed task corresponding to the fourth item information is updated based on the updated occurrence period.

A new triggering point in time may be obtained based on the updated occurrence period and a triggering point-in-time setting strategy of the fourth item information, and then the timed task of the fourth item information may be triggered at a new triggering point in time.

Specific example 5: when the time of Conference 3 is changed from 16:00-17:00 to 17:00-17:30, on the one hand, a new conference list is generated based on new Conference 3 and the originally displayed Conference 1, Conference 2 and Conference 4, and then displayed on the terminal. On the other hand, two timed tasks for Conference 3 are updated from original 15:50 and 16:50 to 16:50 and 17:20.

With the technical solutions of the embodiments of the present disclosure, the item list is updated whenever the item information is detected to be updated, or the occurrence period of the item information is detected to be updated, and when the occurrence period is updated, the triggering point in time of the timed task corresponding to the item information may also be updated, thereby ensuring the accuracy of displaying the item list by the terminal.

In one embodiment, in the implementation environment shown in FIG. 1, the plurality of terminals may include a terminal of a ticket type and a display device of an electronic table card type. The terminal of the ticket type is configured to display a conference list for the entire conference room, and the display device of the electronic table card type is configured to display conference reservation information for an ongoing conference. In addition to updating the item list on the terminal, the server may also update the item information displayed on the display device of the electronic table card type, so that item information of an ongoing item is displayed on the display device of the electronic table card type.

In specific implementation, after the target timed task is determined, the item information corresponding to the target timed task may be sent to a plurality of display devices upon arrival of the occurrence period of the item corresponding to the target timed task, so that the display device may refresh the displayed item information.

Upon arrival of the occurrence period of the item corresponding to the target timed task arriving may refer to: during the occurrence period of the item corresponding to the target timed task, a start moment of the occurrence period or any moment after the start moment. The item information corresponding to the target timed task may be sent to the display device, and the display device may refresh the displayed item information when it receives the item information sent by the server.

In an optional embodiment, the implementation environment shown in FIG. 1 includes a MAC address, remaining power, signal intensity, etc. The server stores the information in a database and displays it on a Web page. Through the Web page, the user may select a conference room to reserve a conference within a time period (a minimum duration of the conference is thirty minutes); and after the conference is successfully reserved, the conference reservation information is sent to the server.

The item information corresponding to the target timed task is sent to the display device after a preset duration from the start moment of the occurrence period of the item corresponding to the target timed task, because the item information may be sent after a period of time from the triggering point in time to avoid the triggering point in time, so as to avoid an event of updating the item information and an event of updating the item list from being sent in close proximity to each other, thereby further reducing network congestion.

The user of the client may determine whether to perform a binding operation based on various information (e.g., power and signal intensity) of the terminal. The significance of the binding operation is that the bound terminal and display device may be used by a conference system, and the conference reservation information may be issued and the conference list may be updated.

To further reduce the intensity of update events, the item list on the current terminal with better performance may be updated during updating the item list. In specific implementation, the current performance parameter sent by a plurality of terminals are received, and the current performance parameter includes at least one of the remaining power and the signal intensity. Then, an item list currently displayed on a target terminal may be updated. The current performance parameter of the target terminal is greater than or equal to a target performance parameter.

In this embodiment, the target terminal may be a terminal with a remaining power greater than the target remaining power, or the target terminal may be a terminal with signal intensity greater than the target signal intensity, or the target terminal may be a terminal with remaining power greater than the target remaining power and signal intensity greater than the target signal intensity.

In an optional example, a current performance parameter-based solution is also applicable to the update of the item information on the display device, and correspondingly, the item information corresponding to the target timed task may be sent to the display device whose current performance parameter is greater than or equal to the target performance parameter in the plurality of display devices, in order to refresh the displayed item information.

In the conference reservation scenario, the display device is an electronic table card, one conference room generally has a plurality of electronic table cards, and the number of electronic table cards is greater than the number of electronic doorplates. Therefore, when item information of the electronic table card with high signal intensity and large remaining power is selected to be updated, update events for sending the item information may be reduced, thereby further reducing the occupation of a network bandwidth by the information.

With the technical solution in this implementation, the update events sent from the server to the terminal may be reduced, thereby further avoiding network congestion, and improving the accuracy of the item list for the target terminal.

Combined with a specific example in the conference reservation scenario, e.g., the implementation environment as shown in FIG. 1, the information processing method in an embodiment of the present disclosure is introduced below.

In S1, after the terminal is scanned by a router through a protocol, the router reports basic information of the terminal to the server; and after the display device is scanned by a Bluetooth gateway through a Bluetooth protocol, the Bluetooth gateway reports the basic information of the display device to the server. The basic information includes a MAC address, power and signal intensity, etc. The server stores the basic information of each terminal and display device in a database and displays it on the Web page.

In S2, the user of the client may determine whether to bind the terminal and the display device based on their basic information. A conference list may be issued by the server to the bound terminal, and the conference reservation information may be issued by the server to the bound display device.

In S3, the user of the client reserves a conference in the conference room and binds some terminals to display a conference list and conference reservation information in the conference room, where the electronic doorplate displays the conference list, and the electronic table card displays the conference reservation information.

In S4, the server receives the conference reservation information sent by the client, and generate a timed task corresponding to the conference reservation information based on the occurrence period of the conference reservation information and the preset triggering point-in-time setting strategy.

One conference reservation information includes two timed tasks, one before the start of the conference and one when the conference is about to end. Each conference reservation information and the corresponding timed task are both stored in the database and are waiting to be triggered.

In S5, before each timed task to be triggered is triggered, a triggering point-in-time interval between the timed task and a next timed task to be triggered is determined. If the triggering point-in-time interval is greater than 5 minutes, step S6 is performed, and otherwise, step S7 is performed.

In S6, one of two timed tasks which corresponds to the conference reservation information with a later occurrence period is retained, while the other timed task is canceled; a conference list generated from the conference reservation information corresponding to the retained timed task and the conference reservation information that is to occur is sent to the terminal at a triggering point in time of the retained timed task, and the terminal receives the conference list and then refreshes the displayed conference list.

After the displayed conference list is updated, the conference reservation information corresponding to the retained timed task is sent to the bound display device after a conference corresponding to the retained timed task starts for a period of time, the conference reservation information includes information about participants, a host, and a conference topic, etc.

In S7, two timed tasks are retained, and the terminal receives the conference list generated by the conference reservation information corresponding to the triggered timed task and the conference reservation information that is to occur at the triggering point in time of each timed task, and refreshes the displayed conference list.

An interval duration between occurrence periods of items corresponding to two timed tasks may be determined; step S8 is performed when the interval duration is greater than a target interval duration; otherwise, step S9 is performed.

In S8, the client sends item idle information, and sends the item list including the item idle information to the terminal to indicate that a time period between two conferences may be reserved.

The item list and item information may be encapsulated by the server through a HTTP protocol and sent to the terminal.

The information processing method of the present disclosure has the following advantages.

In a first aspect, the intensive occurrence of update events within a short period of time and the congestion of network bandwidth are avoided, and the probability of thread crash is reduced, thereby improving the accuracy and success rate of updating the item list.

In a second aspect, when an interval duration between two adjacent items exceeds a certain duration, a time interval where this interval duration is located may be displayed in the item list of the terminal, thereby enriching an update mechanism of the item list, enabling users to directly view time periods which may be reserved from the item list displayed on the terminal, and optimizing the user experience.

In a third aspect, item information of an item that is occurring may be displayed in the display device when the item list displayed on the terminal is updated, thereby displaying item information in two dimensions, enriching the information display scenario and optimizing the user experience.

In a fourth aspect, the triggering point in time of the corresponding timed task may be updated when the occurrence period of the item information is updated, thereby ensuring the accuracy of updating the item list of the terminal.

Based on the same inventive concept, the inventors conceive and propose an improved client. The client may provide item information and a timed task corresponding to the item information to the server, so that the server may select a target timed task from this timed task and the next timed task to be triggered based on the triggering point in time of the timed task and an occurrence period included in the item information before each timed task to be triggered is triggered, so as to cancel the triggering of one timed task in the case of a short triggering point-in-time interval, and avoid the occurrence of intensive update events within a short period of time, as well as network congestion and thread crash, thereby improving the accuracy and success rate of updating the item list displayed on the terminal.

Still combined with the implementation environment as shown in FIG. 1, an information processing method in an embodiment of the present disclosure is introduced. This method may be applied to a client side. Referring to FIG. 3, a flowchart of steps of the information processing method in an embodiment is shown. As shown in FIG. 3, this method may specifically include the following steps.

In step S301, input item information is acquired in response to item input on an item reservation interface.

The item information includes an occurrence period of an item and a corresponding timed task, the timed task is configured to trigger a server at a triggering point in time to update an item list displayed on a terminal, and the item list includes item information of items that are occurring and/or are to occur.

In step S302, the item information is sent to the server, so that the server determines a triggering point-in-time interval between a current timed task to be triggered and a next timed task to be triggered before the current timed task to be triggered is triggered. A target timed task is determined from the current timed task to be triggered and the next timed task to be triggered based on the triggering point-in-time interval and a sequence of the occurrence periods. The item list displayed on the terminal is updated at a triggering point in time of the target timed task.

In this embodiment, the item reservation interface may be understood as a Web page provided by the client for the user to reserve an item. As described in the above server-side embodiment, the item reservation interface may include basic information uploaded by the terminal to the server, and the user may select the terminal for displaying the item list and input the item information on the item reservation interface.

In an optional example, when the item information is input, the triggering point in time of the timed task may be set at the same time. When the triggering point in time of the timed task is set, the client may generate the timed task corresponding to the item information. In another optional example, when the item information is input, a triggering point-in-time setting strategy for the timed task may be set at the same time. For example, five minutes before the occurrence period and/or five minutes before the end of the occurrence period may be set. A plurality of different triggering point-in-time setting strategies may be provided for users to select on the item reservation interface. In this case, the server may generate the corresponding timed task based on the item information and the triggering point-in-time setting strategies.

The process of how the server updates the item list displayed on the terminal based on the timed task of each item information may refer to the above server-side embodiment, and will not be repeated here.

Correspondingly, as described in the above embodiments of the information processing method on the server side, the item list is generated based on the item information of items that are occurring and/or are to occur, and an item list template, where this item list template may be provided on the client side.

In specific implementation, before uploading the item information, the client side may acquire a drawn item list template in response to a drawing completion operation for the item list template on a template setting interface, and upload the item list template to the server, so that the server may generate an item list based on the item list template and the item information of items that are occurring and/or are to occur.

As shown in FIG. 4, a schematic diagram of an item list template for a conference reservation scenario is shown. The process of obtaining the item list template is illustrated below in conjunction with the item list template shown in FIG. 4.

As shown in FIG. 4, the item list template is a template including a table. The template includes a table header and a table body, row and columns, and other information, such as attribute information of a conference room. In the relevant technology, the item list template is generally drawn in a drawing interface provided by Canvas. Canvas is a method provided by HTML5 for drawing graphics on a web page using scripts. However, the native Canvas has some defects, such as the lack of interactive object models, graphic combinations, and object drag and drop scaling. In this case, the item list template is only drawn one cell by one cell. That is, the user needs to draw a plurality of cells and then combine the plurality of cells to form a table, which takes a long time and leads to low efficiency in drawing the item list template.

Therefore, when the inventor conceives the technical solution to solve the above technical problem, a table graphic is regarded as a combined graphic of a plurality of cells, and the cells are regarded as a combined graphic of rectangles and text. According to this idea, a method for drawing an item list template is customized. A specific implementation goal is that: each table graphic may be drawn in batch in the canvas each time, and each cell in the table may be individually configured with a text style. With this implementation, the user only needs to set table attribute parameters to generate a plurality of cells in batch to obtain a table.

To achieve this goal, one way is to use a fabric.js open source library. The fabric.js open source library is ported to a Canvas-based drawing library to realize various visualization operations on window graphics, with the advantage of the overall operation for the graphic combination. In the case that fabric.js is not used, native Canvas and scalable vector graphics (SVG) technology may also be used for drawing and interaction of 2D plane graphics on the web page.

SVG is a language that uses XML to describe 2D graphics. Its biggest advantages over Canvas are as follows: firstly, each drawn graphic is regarded as an object to which an associated event handler may be added; and secondly, the graphic quality of an SVG image will not be lost when it is enlarged or changed in size.

As shown in FIG. 5, a flowchart of steps of obtaining a drawn item list template is shown. As shown in FIG. 5, which may specifically include steps 501-503.

In step S501, a table is generated in response to a table attribute parameter input in the table configuration item.

The table attribute parameter includes at least one of table size, a number of rows and a number of columns.

The table configuration item may be configured to receive the table attribute parameter input by the user. Specifically, the table configuration item may include a height parameter and a width parameter of the table. The number of cells and coordinate values of each cell may be calculated based on the table attribute parameters according to a table coordinate system, so that a plurality of cells may be generated in a loop based on the coordinate values of each cell, and then the table is obtained.

In specific implementation, during implementing the step S501, the following process may be adopted.

Firstly, in response to the table attribute parameter input in the table configuration item, a table coordinate system of a display screen to be displayed is acquired; and then position coordinates of each cell in the table coordinate system are determined based on the table attribute parameter and the table coordinate system, and the table is generated based on the position coordinates of each cell in the table coordinate system.

In an optional embodiment, the table attribute parameters include a table size, a number of rows and a number of columns, the table size includes a length and a width of the table. The table coordinate system may be a display coordinate system of display screen. The number of rows and the number of columns may be configured to determine the number of cells based on the table size, and then the coordinates of each cell are determined based on the display coordinate system. As shown in FIG. 6, a schematic diagram for calculating position coordinates of each cell based on the table coordinate system is shown.

The table has a width of width, a height of height, and a number of columns of n; each cell has a width of tw and a height of th; index is the i^{th} column; and rowIndex is the i^{th} row.

where tw=width/n;

left=width/2+tw*(index−1), and the height of the table header is calculated as follows: th=−height/2, and th of the table body=−height/2+th*(rowIndex+1).

A maximum number of rows displayed in the item list template is dynamically calculated. When the number of rows in the table is calculated, the height of the entire canvas is used, and the number of rows is calculated based on the row height.

Therefore, the position of each cell (i.e., the length and width of each cell) in the table coordinate system may be obtained, so that the corresponding cell at each corresponding position is generated in a loop and thus the table is obtained.

In step S502, text input in the table configuration item for a cell as a table header and table header text attributes of the text are received.

The header text attribute includes one or more attributes such as font size, color, position, and etc. of the text. In practice, the table header text attributes may be input or selected in the table configuration item. Details may refer to the similar implementation process of selecting a font style in the relevant technology. The configured text may be input for the cell as the table header.

In step S503, the corresponding text is added to the cell as the table header based on the table header text attributes to obtain the item list template.

In this embodiment, in the generated table, the corresponding text may be added to the cell as the table header based on the table header text attributes, thereby obtaining the item list template as shown in FIG. 4.

Correspondingly, a flowchart of steps for drawing an item list template is also provided. In this embodiment, before step S503, a process for setting text attributes in the table body may also be included. Specifically, the table body text attributes input in the table configuration item for a cell that is not a table header may be received. Correspondingly, in step S503, the corresponding text may be added to the cell as the table header based on the table header text attributes, and the table header text attributes may be bound to the corresponding cells to obtain the item list template.

The table body text attribute may also include one or more attributes such as font size, color, position, etc. of the text. The table body text attributes are configured to specify a text style of the cell in the table body. Since the text in the cell of the table body is added later by the server based on the item information, the table body text attributes may be carried in the item list template and bound to the corresponding cell.

The table body text attribute and the table header text attributes may both include a position attribute of the text. The position attribute may indicate whether the text is located in the center, on the left, on the right, on the top, on the bottom, etc. of the cell. Therefore, in an optional example, the position coordinates of text in each cell are determined based on the position attributes.

Specifically, for each cell, because the position coordinates of each cell are obtained, the position coordinates of the text in the cell may be calculated based on the position coordinates of the cell and the position attribute of the cell, where the position coordinates are used as parameters of the cell.

After the item list template is drawn, the item list template may be exported as in JavaScript Object Notation (JSON) type data and uploaded to the server. Therefore, the server may add each item information to a corresponding position of the JSON type data when the item list is generated, so as to obtain JSON type to-be-rendered data. Then, the JSON type to-be-rendered data is sent to the server. On the terminal side, the item list may be rendered based on the JSON type to-be-rendered data.

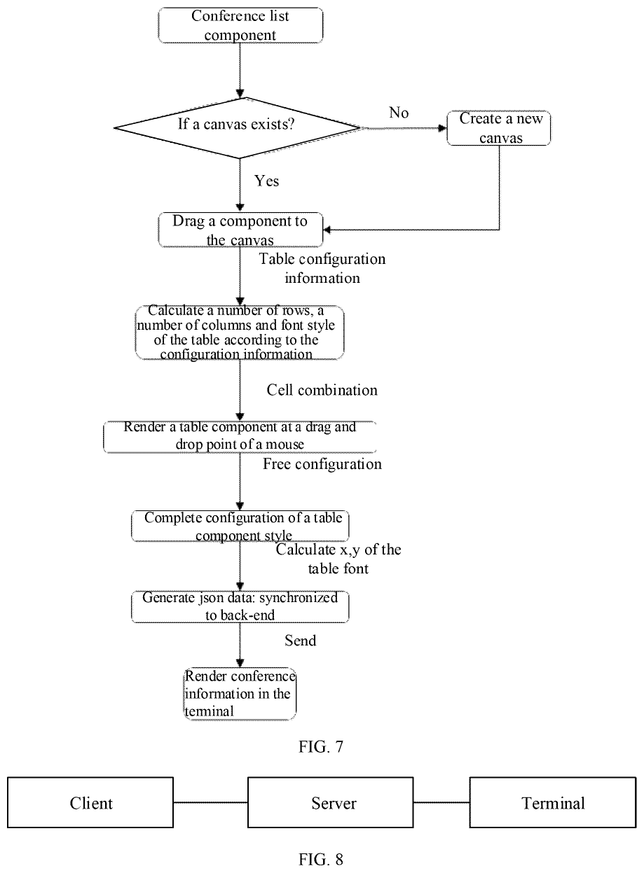

As shown in FIG. 7, an overall schematic flowchart of how to obtain a conference list template (corresponding to the item list template) in a conference reservation scenario is shown, which may specifically include the following process as shown in FIG. 7.

Firstly, a conference list component is selected on a template setting interface; if there is already a drawing canvas, a cell component is directly dragged to the drawing canvas; and if there is no drawing canvas, it is necessary to newly create a drawing canvas.

Then, the table attribute parameter and table header text attribute (configuration information in FIG. 7) are input in the table configuration items, and the number of rows, the number of columns and the font style of the table are calculated based on the table attribute parameters.

Next, the cell component is clicked, dragged on the drawing canvas, and released with a mouse to render the table.

Then, the table header text attributes, the table body text attributes and the table header text are input to complete the configuration of a table component style.

Finally, an export control is clicked to export a conference list template in JSON format, which is synchronized to a back-end (server) and finally sent by the server to the terminal.

In one embodiment, undo/restore becomes necessary to facilitate the user to modify the item list template when frequent modifications and edits may be required during drawing the item list template.

In the related art, during drawing the item list template in a drawing interface provided by Canvas, the Canvas-based drawing interface less supports undo/redo. In view of this, the inventor ports the fabric.js open source library to a Canvas-based drawing library to achieve the “undo/redo” function by using a method for exporting and importing content on the canvas.

The general implementation idea is as follows: firstly, an undo/redo dataset and a pointer representing the current index are maintained; after the data on the canvas and data in an editing area of the canvas are modified, the data content is exported; and when the undo/redo operation is performed, changes in a data object may be monitored, and data is imported to restore the content on the canvas.

Specifically, in one embodiment, before acquiring the drawn item list template, for each drawing operation on the template setting interface, template elements generated based on this drawing operation may be recorded, and in response to a triggered undo/redo operation, a target template element corresponding to the undo/redo operation in the recorded template elements may be rendered to the drawing canvas.

Each template element represents an item list template modified each time. The drawing operation includes, but is not limited to, any of a drawing operation for graphics in the item list template, and an editing operation for the table attribute parameter.

In this embodiment, each drawing operation may be understood as a data modification operation, which includes a drawing operation for the graphics on the canvas and an editing operation for texts in the editing area. The editing operation for the table attribute parameter may include: a modification operation for the table attribute parameter in the table configuration item, a modification operation for the table header text attribute and the table body text attribute, and a modification operation for the table header text. The drawing operation for graphics may refer to drawing operation for the cell component, e.g., a selection operation for a style of the cell component and a scaling operation for the cell component.

In this embodiment, as elements in the editing area (including configuration fields for the drawing canvas and table configuration item) change, e.g., the user adds a new graphic control, move a graphic position or modifies graphic attributes, the content on the canvas at the completion of the drawing operation may be exported as a template element for each drawing operation. This template element may be approximately understood as an uncompleted item list template. That is, as long as the user has not clicked to upload the item list template, each previous drawing operation corresponds to a version of the item list template, and each version of the item list template is called a template element.

Exemplarily, one drawing operation is as follows: the height of the table in the table attribute parameters is modified from 220 mm (millimeter) to 210 mm; and then, for this modification, the entire data content on the canvas may be exported. The exported data content may be regarded as an item list template which has a height of 210 mm, and the height of the table in the template elements exported before the modification is 210 mm.

When the undo/redo operation is triggered on the template setting interface, the corresponding target template element may be selected from the plurality of stored template elements and rendered to the drawing canvas. Specifically, a method for importing content on the canvas provided by the fabric.js, e.g., Canvas.loadFromJSON (CanvasData), may be used to restore the content of the drawing canvas.

The undo in undo/redo may refer that the user wants to restore a data state before the modification; and the redo may refer that the user returns to a data state at a modification and then restores a data state at the next modification.

For example, in the n^{th} modification, the user modifies the height of the table from 220 mm to 210 mm; in the (n+1)^{st} modification, the user modifies the height of the table from 210 mm to 200 mm; and in the (n+2)^{nd} modification, the user modifies the height of the table from 210 mm to 215 mm. The undo may refer that the user wants to restore the state at the n^{th} modification in the (n+2)^{nd} modification. The redo may refer that the user wants to restore the state at the (n+1)^{st} modification or the (n+2)^{nd} modification when the user returns to the state at the n^{th} modification. It may also be seen that the redo operation is performed based on the undo operation.

When the target template element corresponding to the undo/redo operation in the recorded template elements may be rendered to the drawing canvas, the target template element may be determined based on an operation step length. Specifically, an operation step length of the undo/redo operation may be determined. Based on the operation step length, the target template element corresponding to the operation step length may be searched for starting from a last recorded template element, and the target template element is rendered to the drawing canvas. The operation step length includes a step length of an undo type and a step length of a redo type.

As described in the above embodiment, the redo operation is performed based on the undo operation. Therefore, the operation step length may include the step length of the undo type and the step length of the redo type. The step length of the undo type is for the undo operation, which may also be understood as a step length of a backward type; and the step length of the redo type is for the redo operation, which may also be understood as a step length of a forward type.

In an optional embodiment, when the undo operation is performed, the target template element may be determined from template elements starting from the last recorded template element, based on the operation step length of the undo operation, e.g., the number of clicks on the undo control of the backward type (the operation step length of the backward type). When the user performs the redo operation, a final target template element may be determined from template elements between the target template element corresponding to the undo operation and the last recorded template element based on the operation step length of the redo operation, e.g., the number of clicks on the undo control of the forward type (the operation step length of the forward type).

In an optional embodiment, a global state object may be maintained to save the template elements in the global state object. In specific implementation, a global state object corresponding to the drawing canvas may be created, and each time a template element is recorded, the template element and a number of operation steps corresponding to the template element are recorded in the global state object, where the number of operation steps represents the drawing operation corresponding to the template element.

Of course, if the global state object is maintained, the template element corresponding to the number of operation steps and the operation step length may be searched for from the global state object based on the operation step length.

The global state object includes an array StepArr for recording template elements, Current for recording the number of operation steps which represents a number of drawing operations for obtaining the template element, i.e., a total number of drawing operations, stepLength for recording the operation step length of the undo/redo operation; and CanvasData for recording data on the current drawing canvas, which refers to page data to be updated, and is a character string in JSON format. Each time the undo/redo operation is performed, the corresponding template element may be fetched from the array StepArr, and the data object may be updated.

Each time a drawing operation is detected, the template element corresponding to the drawing operation may be recorded to an array of the global state object.

In one embodiment, various template elements in the global state object may be arranged in the order of number of operation steps. In order to improve the accuracy of searching for the target template element from the array, template elements behind the target template element may be deleted in the case that the target template element is not the last recorded template element in each undo/redo operation when the target template element is determined. Correspondingly, during recording the template element and the number of operation steps corresponding to the template element in the global state object at each recording of a template element, the template element may be appended to the tail of the queue of template elements and the number of operation steps of the template element may be updated.

Exemplarily, in the n^{th} modification, the user modifies the table height from 220 mm to 210 mm; in the (n+1) $1 modification, the user modifies the height from 210 mm to 200 mm; and in the (n+2)^{nd} modification, the user modifies the height from 210 mm to 215 mm. The undo operation indicates to restore to the state at the n^{th} modification in the (n+2)^{nd} modification and click “Save” (indicating that the (n+1)^{st} modification and the (n+2)^{nd} modification are not required). That is, the (n+1)^{st} modification and the (n+2)^{nd} modification are deleted from the global state object. In the (n+3)^{rd} modification, the height of the table is modified to 208 mm. Data after the (n+3)^{rd} modification is added to data after the n^{th} modification as a new template element for the (n+1)^{st} modification. Then, the number of operation steps of the drawing operation in the global state object is modified from n+3 to n+1.

In this case, if the user wants to restore the table height of 210 mm, that is, the n^{th} modified data, after the (n+3)^{rd} modification, the undo operation has a step length of 1. However, in the global state object, the number of operation steps may be obtained as data corresponding to the n^{th} modification, that is, the table height is 210 mm, by counting forward 1 from the last template element forward.

With this implementation, because the data behind the target template element positioned by the undo/redo operation is deleted, the data may be deleted in time, and a storage space of the global state object is released. Meanwhile, the number of operation steps of the global state object is updated, which may ensure that the operation step length of the subsequent undo/redo operation may correctly correspond to the number of operation steps of each template element maintained in the global state object, thereby improving the accuracy of finding out the target template element.

Correspondingly, in an optional embodiment, the template elements at the front of global state object element may be deleted if the number of template elements in the global state object exceeds a target number.

In specific implementation, after the template elements are appended to the global state object, if a size of the array after the template elements are appended has exceeded a maximum number of steps, that is, the target number, it is necessary to delete an elements at the front of the global state object. That is, the template elements in the global state object are deleted according to a first-in and first-out principle.

Of course, for the redo operation, the operation step length of the redo operation will not move again if it has already been pointed to the last template element, and the drawing canvas will indicate that it is already the last step.

As described above, the item list template may be exported as data in JSON type and then uploaded to the server, where the corresponding template element may be taken a snapshot during recording each drawing operation on the template setting interface. During undo/redo, the corresponding snapshot may be extracted, and the template element may be restored based on the snapshot.

In specific implementation, for each drawing operation on the template setting interface, the current content on the drawing canvas may be exported as data in JSON format; and the exported data in JSON format may be taken as a snapshot to be used as the recorded template element.

In this way, during rendering the target template element to the drawing canvas, data in JSON format corresponding to the target template element may be imported to the drawing canvas to display the item list template corresponding to the template element on the drawing canvas.

With the client implementation and use of the idea of data snapshot, a set of template elements for undo/redo and a pointer indicating the number of current operation steps may be maintained to facilitate locating the corresponding template element. For each drawing operation, the content on the drawing canvas may be exported as data in JSON format. When the undo/redo operation is performed, the corresponding data in JSON format is imported to restore the content on the canvas. Since the data in JSON format is used as a snapshot to restore the content on the drawing canvas, the convenience of undo/redo may be improved.

Based on the same inventive concept, the present disclosure further provides an information processing system. With reference to FIG. 8, a schematic framework diagram of the information processing system is shown. As shown in FIG. 8, the information processing system includes:
a client, configured to send a plurality of item information to a server, where each item information includes an occurrence period of an item and a corresponding timed task, the timed task is configured to trigger the server to update an item list displayed on a terminal, and the item list includes item information of items which are occurring and/or are to occur;
the server, configured to determine a next second timed task to be triggered before triggering the current first timed task to be triggered; determine a target timed task from the first timed task and the second timed task based on a sequence of the occurrence periods and an interval between triggering points in time of the first timed task and the second timed task; and update the item list displayed on the terminal at a triggering point in time of the target timed task; and
a terminal, configured to refresh a currently displayed item list based on the item list sent by the server.

The server may be configured to perform the information processing method described in the above server embodiment, and the client may be configured to execute the information processing method described in the above client embodiment. A plurality of terminals and a plurality of display devices may be included. The display device may be an electronic table card. The terminal may be an electronic doorplate, and of course, may also include other types of terminals, such as a large-size display screen.

Next, the practical application process of the information processing system is described.

In a first step, a template design user logs in to the client and uses a Canvas-based drawing library provided by the client to design the item list template, where the Canvas-based drawing library uses a fabric.js open source library.

In a second step, the template design user selects a conference list component on the template setting interface, selects a style of cell component and drags it to the drawing canvas, and then inputs a table attribute parameter, a table header text, a table header text attribute, and a table body text attribute in the configuration field.

In a third step, in response to the drag movement operation of the user for the cell component on the drawing canvas, the client generates a plurality of cells in batches based on the cell component selected by the user, table attribute parameters, table header texts, table header text attributes and table body text attributes, thereby obtaining a table.

During the second and third steps, the client records each drawing operation of the user, saves snapshots of the template elements under each drawing operation, determines a target snapshot from the saved snapshots when the undo/redo operation of the user is detected, and then imports the target snapshot to the drawing canvas to facilitate the user's editing of the conference list template involved.

In a fourth step, in response to a determination operation from the user, the client exports the data on the current drawing canvas as list data in JSON format and uploads it to the server. The list data in JSON format is the conference list template.

Based on the process from the first step to the fourth step, the template design user may draw a plurality of different styles of conference list templates for conference reservation users to select and use.

In a fifth step, the conference reservation user logs in to the client, inputs the conference reservation interface, inputs conference reservation information, selects a triggering point-in-time setting strategy, and selects a conference list template from a plurality of drawn conference list templates. The client sends the conference reservation information input by the user, the selected triggering point-in-time setting strategy and the conference list template to the server.

In a sixth step, the server generates a timed task for the conference reservation information based on the conference reservation information and the selected triggering point-in-time setting strategy, and determines a triggering point in time of the timed task.

In a seventh step, the server updates the conference list displayed on the terminal based on the triggering point in time of the timed task. The specific process may refer to the exemplary illustration on the server, and will not be repeated here.

The embodiment further provides an electronic device including a memory, a processor and a computer program stored in the memory and run on the processor, where the processor is configured to implement the information processing method when executing the program.

The present disclosure further provides a non-transient computer-readable storage medium storing a computer program which causes a processor to perform the information processing method.

For the information processing system embodiment, since it is basically similar to the information processing method embodiment, the description of the information processing system is relatively simple. For relevant parts, please refer to part of description of the method embodiment.

The various embodiments in the present description are described in a progressive manner. Each embodiment focuses on the differences from the other embodiments, and the same or similar parts between the various embodiments may be referred to each other.

Based on the same inventive idea, the present disclosure provides an information processing apparatus applied to a server side. The apparatus includes:
an information receiving module, configured to receive a plurality of item information sent by a client, where each item information includes an occurrence period of an item and a corresponding timed task, the timed task is configured to trigger the server at a triggering point in time to update an item list displayed on a terminal, and the item list includes item information of items which are occurring and/or are to occur;
a timed triggering module, configured to determine a triggering point-in-time interval between the current timed task to be triggered and a next timed task to be triggered before the current timed task to be triggered is triggered; and
a list updating module, configured to determine a target timed task from the current timed task to be triggered and the next timed task to be triggered based on the triggering point-in-time interval and a sequence of occurrence periods, and update the item list displayed on the terminal at a triggering point in time of the target timed task.

Alternatively, the list updating module includes:
a first determining unit, configured to determine that the current timed task to be triggered and the next timed task to be triggered are both the target timed tasks when the triggering point-in-time interval is greater than a first preset threshold; and
a second determining unit, configured to determine that one of the current timed task to be triggered and the next timed task to be triggered which occurs at a later period is the target timed task when the triggering point-in-time interval is not greater than a first preset threshold.

Alternatively, the apparatus further includes:
an interval duration determining module, configured to determine an interval duration between a first occurrence period and a second occurrence period when the triggering point-in-time interval is greater than or equal to a second preset threshold, where the first occurrence period is an occurrence period of an item corresponding to the current timed task to be triggered, and the second occurrence period is an occurrence period of an item corresponding to the next timed task to be triggered;
an idle information generating module, configured to generate item idle information based on the first occurrence period and the second occurrence period when the interval duration is greater than or equal to a target interval duration, where the item idle information is configured to indicate that a period between the first occurrence period and the second occurrence period may be reserved; and
an idle information sending module, configured to add the item idle information to the item list displayed on the terminal so as to display the period which may be reserved in the item list.

Alternatively, the item list is generated by the following:
receiving an item list template sent by the client; and
generating the item list based on the item list template and the item information of items which are occurring and/or are to occur.

Alternatively, the list updating module includes:
an information acquiring unit, configured to acquire first item information corresponding to the target timed task and second item information at the triggering point in time of the target timed task, where an occurrence period of the second item information is after the occurrence period of item information corresponding to the target timed task;
a state updating unit, configured to update a state of the first item information and a state of the second item information which include an occurring state and a non-occurring state;
a list generating unit, configured to generate a new item list based on the first item information and the second item information, as well as their respective updated states; and
a list sending unit, configured to send the new item list to the terminal to update the item list displayed on the terminal.

Alternatively, the apparatus further includes:
an information update detecting module, configured to, when it is detected that any third item information in the plurality of the item information is updated, generate a corresponding updated item list based on the updated third item information and the item list currently displayed on the terminal; and
an information update sending module, configured to send the updated item list to the terminal, such that the terminal refreshes the displayed item list.

Alternatively, the triggering point in time of the timed task corresponding to each item information is determined based on an occurrence period of the item information, and the apparatus further includes:
a triggering point-in-time updating module, configured to, when it is detected that an occurrence period of any fourth item information in the plurality of item information is updated, update a triggering point in time of a timed task corresponding to the fourth item information based on the updated occurrence period.

Alternatively, a plurality of terminals is included, and the apparatus further includes:
a performance parameter acquiring module, configured to receive a current performance parameter sent by each of the plurality of terminals, wherein the current performance parameter includes, but is not limited to, at least one of remaining power and signal intensity; and
a list updating module, configured to update an item list displayed on a target terminal at the triggering point in time of the target timed task, where the current performance parameter of the target terminal is greater than or equal to a target performance parameter.

Based on the same invention concept, this application provides an information processing apparatus applied to a client side. The apparatus includes the following modules:
an item information receiving module, configured to acquire input item information in response to item input on an item reservation interface, where the item information includes an occurrence period of an item and a corresponding timed task, the timed task is configured to trigger a server at a triggering point in time to update an item list displayed on a terminal, and the item list includes item information of items which are occurring and/or are to occur; and
an information sending module, configured to send the item information to the server, so that the server determines a triggering point-in-time interval between a current timed task to be triggered and a next timed task to be triggered before triggering the current timed task to be triggered; determine a target timed task from the current timed task to be triggered and the next timed task to be triggered based on the triggering point-in-time interval and a sequence of the occurrence periods; and update the item list displayed on the terminal at a triggering point in time of the target timed task.

Alternatively, the apparatus further includes:
an item list acquiring module, configured to acquire a drawn item list template in response to a drawing completion operation for an item list template on a template setting interface; and
an exporting module, configured to export the item list template as data in JSON, type, and upload it to the server, so that the server generates an item list based on the acquired item list template and the item information of items which are occurring and/or are to occur.

Alternatively, the template setting interface includes a table configuration item. The item list acquiring module includes:
a table generating unit, configured to generate a table in response to a table attribute parameter input in the table configuration item, where the table attribute parameter includes at least one of table size, a number of rows and a number of columns;
a first text attribute acquiring unit, configured to receive text input in the table configuration item for a cell as a table header, and a table header text attribute of the text; and
a template generating unit, configured to add the corresponding text to the cell as the table header based on the table header text attribute to obtain the item list template.

Alternatively, the apparatus further includes:
a second text attribute acquiring unit, configured to receive a table body text attribute input in the table configuration item for a cell that is not a table header; and
the template generating unit, configured to add the corresponding text to the cell as the table header based on the header table text attribute, and bind the table body text attribute to the corresponding cell to obtain the item list template.

Alternatively, the table generating unit includes:
a coordinate system acquiring subunit, configured to acquire a table coordinate system of a display screen to be displayed in response to the table attribute parameter input in the table configuration item;
a position coordinate determining subunit, configured to determine a position coordinate of each cell in the table coordinate system based on the table attribute parameter and the table coordinate system; and
a table generating subunit, configured to generate the table based on the position coordinate of each cell in the table coordinate system.

Alternatively, the template setting interface includes a drawing canvas. The apparatus further includes:
a data recording module, configured to, for each drawing operation on the template setting interface, record template elements generated under the drawing operation, where each template element represents an item list template modified each time, the drawing operation included, but is not limited to, any of a drawing operation for graphics in the item list template, and an editing operation for the table attribute parameters; and
a data restoring module, configured to, in response to a triggered undo/redo operation, render a target template element corresponding to the undo/redo operation in the recorded template elements to the drawing canvas.

Alternatively, the data recording module includes:
an exporting unit, configured to, for each drawing operation on the template setting interface, export current content on the drawing canvas as data in JSON format; and
a snapshotting unit, configured to take a snapshot of the exported data in JSON format as a recorded template element.

Alternatively, the data restoring module includes:
an operation step length determining unit, configured to determine an operation step length of the undo/redo operation; and
an element search unit, configured to search, based on the operation step length, a target template element corresponding to the operation step length from a last recorded template element, and render the target template element to the drawing canvas, where the operation step length includes a length step of an undo type and a step length of a redo type.

Alternatively, the apparatus further includes:
an object creating module, configured to create a global state object corresponding to the drawing canvas;
a recording module, configured to, at each recording of a template element, record the template element and a number of operation steps corresponding to the template element in the global state object, where the number of operation steps is configured to indicate a drawing operation corresponding to the template element; and
the element search unit, configured to search, based on the operation step length, a template element, corresponding to the number of operation steps from the global state object.

Alternatively, the apparatus further includes:
a deleting module, configured to, deleting template elements behind the target template element when the target template element is not the last recorded template element; and/or deleting template elements arranged at front of the target template element when a number of template elements in the global state object exceeds a target number; and
a recording module, configured to, at each recording of the template element, append the template element to the tail of a queue of the template elements, and update the number of operation steps for the template element.

A specific implementation process of the information processing apparatus embodiment, which is similar to a specific implementation process of the information processing method embodiment which may be referred, and will not be repeated here.

Finally, it should also be noted that, unless otherwise defined, terms such as “first” and “second”, etc. as used herein do not indicate any order, quantity or significance, but are merely intended to distinguish different components. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “comprising a . . . ” does not exclude additional same element in the process, method, article or device comprising the element. Terms such as “connect” and “couple” are not limited to physical or mechanical connection, but may include electrical connections, whether direct or indirect.

The information processing method, the information processing system and the electronic device have been described in detail above. The principle and the embodiments of the present disclosure are described herein with reference to the particular examples, and the description of the above embodiments is merely intended to facilitate to understand the method according to the present disclosure and its core concept. Moreover, for a person skilled in the art, according to the concept of the present disclosure, the particular embodiments and the range of application may be varied. In conclusion, the contents of the description should not be understood as limiting the present disclosure.

After considering the specification and practicing the inventions disclosed here, a person skilled in the art will easily think of other embodiments of the present disclosure. The present disclosure aims to cover any variations, uses or adaptive changes in present disclosure. These variations, uses or adaptive changes follow the general principles of the present disclosure and include public knowledge or common technical means in this art that are not disclosed in the present disclosure. Specification and embodiments are only treated as illustrative, and the true scope and spirit of this disclosure are stated in the following claims.

It should be understood that the present disclosure is not limited to the accurate structure that has been described above and shown in the drawings, and may have various modifications and variations without departing from its scope. The scope of the present disclosure is merely limited by the appended claims.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

A great deal of detail is provided in the manual provided here. However, it is understood that this disclosed embodiment can be practiced without such specific details. In some instances, known methods, structures and techniques are not detailed so as not to obscure the understanding of this specification.

In the claims, any reference signs between parentheses should not be construed as limiting the claims. The word “comprise” does not exclude elements or steps that are not listed in the claims. The word “a” or “an” preceding an element does not exclude the existing of a plurality of such elements. The present application may be implemented by means of hardware comprising several different elements and by means of a properly programmed computer. In unit claims that list several devices, some of those devices may be embodied by the same item of hardware. The words first, second, third and so on do not denote any order. Those words may be interpreted as names.

Finally, it should be noted that the above embodiments are only used to illustrate the technical solutions of the present disclosure, but not to limit them; although the present disclosure has been described in detail with reference to the foregoing embodiments, those of ordinary skill in the art should understand that: they can still modify the technical solutions recorded in the foregoing embodiments, or they can equivalently replace some technical features thereof; and these modifications or replacements do not make the essence of the corresponding technical solutions deviate from the spirit and scope of the technical solutions of the embodiments of the present disclosure.

1. An information processing method applied to a server, comprising:
receiving a plurality of item information sent by a client, wherein each item information comprises an occurrence period of an item and a corresponding timed task, the timed task is configured to trigger the server at a triggering point in time to update an item list displayed on a terminal, and the item list comprises item information of items which are occurring and/or are to occur;
determining a triggering point-in-time interval between a current timed task to be triggered and a next timed task to be triggered before the current timed task to be triggered is triggered; and
determining a target timed task from the current timed task to be triggered and the next timed task to be triggered based on the triggering point-in-time interval and a sequence of the occurrence periods, and updating the item list displayed on the terminal at a triggering point in time of the target timed task.

2. The method according to claim 1, wherein the determining the target timed task from the current timed task to be triggered and the next timed task to be triggered based on the triggering point-in-time interval and the sequence of the occurrence periods comprises:
determining that the current timed task to be triggered and the next timed task to be triggered are target timed tasks when the triggering point-in-time interval is greater than a first preset threshold; and
determining that one with a later occurrence period of the current timed task to be triggered and the next timed task to be triggered is the target timed task when the triggering point-in-time interval is not greater than the first preset threshold.

3. The method according to claim 1, wherein the method further comprises:
determining an interval duration between a first occurrence period and a second occurrence period when the triggering point-in-time interval is greater than or equal to a second preset threshold, wherein the first occurrence period is an occurrence period of an item corresponding to the current timed task to be triggered, and the second occurrence period is an occurrence period of an item corresponding to the next timed task to be triggered;
generating item idle information based on the first occurrence period and the second occurrence period when the interval duration is greater than or equal to a target interval duration, wherein the item idle information is configured to indicate that a period between the first occurrence period and the second occurrence period may be reserved; and
adding the item idle information to the item list displayed on the terminal, so as to display the period which may be reserved in the item list.

4. The method according to claim 1, wherein the item list is generated by:
receiving an item list template sent by the client; and
generating the item list based on the item list template and the item information of items which are occurring and/or are to occur.

5. The method according to claim 1, wherein the updating the item list displayed on the terminal at the triggering point in time of the target timed task comprises:
acquiring first item information corresponding to the target timed task and second item information at the triggering point in time of the target timed task, wherein an occurrence period of the second item information is after an occurrence period of item information corresponding to the target timed task;
updating a state of the first item information and a state of the second item information which comprise an occurring state and a non-occurring state;
generating a new item list based on the first item information and the second item information and their updated states; and
sending the new item list to the terminal to update the item list displayed on the terminal.

6. The method according to claim 1, wherein after the updating the item list displayed on the terminal at the triggering point in time of the target timed task, the method further comprises:
when any third item information in the plurality of item information is detected to be updated, generating an updated item list based on the updated third item information and the item list displayed on the terminal; and
sending the updated item list to the terminal, so that the terminal refreshes the displayed item list.

7. The method according to claim 1, wherein triggering point in time of a timed task corresponding to each item information is determined based on an occurrence period of the item information, and the method further comprises:
when an occurrence period of any fourth item information in the plurality of item information is detected to be updated, updating a triggering point in time of a timed task corresponding to the fourth item information based on the updated occurrence period.

8. The method according to claim 1, wherein a plurality of terminals are comprised, and the method further comprises:
receiving a current performance parameter sent by each of the plurality of terminals, wherein the current performance parameter comprises, but is not limited to, at least one of remaining power and signal intensity; and
the updating the item list displayed on the terminal at the triggering point in time of the target timed task comprises:
updating the item list displayed on a target terminal at the triggering point in time of the target timed task, wherein the current performance parameter of the target terminal is greater than or equal to a target performance parameter.

9. An information processing method applied to a client, comprising:
acquiring input item information in response to item input on an item reservation interface, wherein the item information comprises an occurrence period of an item and a corresponding timed task, the timed task is configured to trigger a server at a triggering point in time to update an item list displayed on a terminal, and the item list comprises item information of items which are occurring and/or are to occur;
sending the item information to the server, so that the server determines a triggering point-in-time interval between a current timed task to be triggered and a next timed task to be triggered before the current timed task to be triggered is triggered, determines a target timed task from the current timed task to be triggered and the next timed task to be triggered based on the triggering point-in-time interval and a sequence of the occurrence periods, and updates the item list displayed on the terminal at a triggering point in time of the target timed task.

10. The method according to claim 9, before the sending the item information to the server, the method further comprises:
acquiring a drawn item list template in response to completion of a drawing operation for an item list template on a template setting interface; and
exporting the item list template as JavaScript Object Notation (JSON) type data, and uploading the item list template to the server, so that the server generates the item list based on the acquired item list template and the item information of items which are occurring and/or are to occur.

11. The method according to claim 10, wherein the template setting interface comprises a table configuration item, and the acquiring the drawn item list template in response to completion of the drawing operation for the item list template on the template setting interface, comprises:
generating a table in response to a table attribute parameter input in the table configuration item, wherein the table attribute parameter comprises at least one of table size, a number of rows and a number of columns;
receiving text input in the table configuration item for a cell as a table header, and a table header text attribute of the text; and
adding a corresponding text to the cell as the table header based on the table header text attribute to obtain the item list template.

12. The method according to claim 11, wherein before the adding the corresponding text to the cell as the table header based on the table header text attribute to obtain the item list template, the method further comprises:
receiving a table body text attribute input in the table configuration item for a cell that is not a table header; and
the adding the corresponding text to the cell as the table header based on the table header text attribute to obtain the item list template comprises:
adding a corresponding text to the cell as the table header based on the table header text attribute and binding the table body text attribute to a corresponding cell to obtain the item list template.

13. The method according to claim 11, wherein the generating the table in response to the table attribute parameter input in the table configuration item comprises:
acquiring a table coordinate system of a display screen to be displayed in response to the table attribute parameter input in the table configuration item;
determining a position coordinate of each cell in the table coordinate system based on the table attribute parameter and the table coordinate system; and
generating the table based on the position coordinate of each cell in the table coordinate system.

14. The method according to claim 10, wherein the template setting interface comprises a drawing canvas, and before the acquiring the drawn item list template in response to completion of the drawing operation for the item list template on the template setting interface, the method further comprises:
recording, for each drawing operation on the template setting interface, a template element generated based on the drawing operation, wherein each template element represents an item list template modified each time, the drawing operation comprises, but is not limited to, any of a drawing operation for graphics in the item list template and an editing operation for the table attribute parameter; and
in response to a triggered undo/redo operation, rendering a target template element corresponding to the undo/redo operation in the recorded template elements to the drawing canvas.

15. The method according to claim 14, wherein the recording, for each drawing operation on the template setting interface, the template element generated based on the drawing operation comprises:
exporting, for each drawing operation on the template setting interface; current content on the drawing canvas as data in JSON format; and
taking a snapshot of the exported data in JSON format as a recorded template element.

16. The method according to claim 14, wherein in response to the triggered undo/redo operation, rendering the target template element corresponding to the undo/redo operation in recorded template elements to the drawing canvas comprises:
determining an operation step length of the undo/redo operation; and
searching, based on the operation step length, for a target template element corresponding to the operation step length since a last recorded template element, and rendering the target template element to the drawing canvas, wherein the operation step length comprises a length step of an undo type and a step length of a redo type.

17. The method according to claim 16, further comprising:
creating a global state object corresponding to the drawing canvas;
recording, at each recording of a template element, the template element and a number of operation steps corresponding to the template element in the global state object, wherein the number of operation steps is configured to indicate a drawing operation corresponding to the template element; and
the searching, based on the operation step length, for the target template element corresponding to the operation step length since the last recorded template element comprises:
searching, based on the operation step length, for a template element corresponding to a number of operation steps and the operation step length from the global state object.

18. The method according to claim 17, wherein template elements in the global state object are arranged in an order of a number of operation steps, and the method further comprises:
deleting template elements behind the target template element when the target template element is not the last recorded template element; and/or deleting template elements arranged at the front when a number of template elements in the global state object exceeds a target number; and
recording, at each recording of a template element, the template element and a number of operation steps corresponding to the template element in the global state object comprises:
appending, at each recording of the template element, the template element to a tail of a queue of the template elements, and updating the number of operation steps for the template element.

19. An information processing system, comprising:
a client, configured to send a plurality of item information to a server, wherein each item information comprises an occurrence period of an item and a corresponding timed task, the timed task is configured to trigger the server to update an item list displayed on a terminal, and the item list comprises item information of items which are occurring and/or are to occur;
a server, configured to determine a second timed task to be triggered before a current first timed task to be triggered is triggered, determine a target timed task based on a sequence of the occurrence periods and an interval between triggering points in time of the first timed task and the second timed task, and update the item list displayed on the terminal at a triggering point in time of the target timed task; and
a terminal, configured to refresh the displayed item list based on the item list sent by the server.

20. An electronic device, comprising a memory, a processor and a computer program stored in the memory and run on the processor, wherein the processor, when executing, performs the information processing method according to claim 1.

21. (canceled)
